(19) United States
(12) Patent Application Publication
(10) Pub. No.: US 2012/0260699 A1
(43) Pub. Date: Oct. 18, 2012

(54) Card for Trolley Lock

(76) Inventor: Gunnar Myhre, Drammen (NO)

(21) Appl. No.: 13/086,471

(22) Filed: Apr. 14, 2011

(51) Int. Cl. E05B 65/52

(52) U.S. Cl. 70/63

(57) ABSTRACT

A card for a trolley lock includes a card body that can be stored inside a wallet to allow users to carry it around easily. Surfaces of the card can be printed of information such as an advertisement, a pattern, a catalog, and daily supplies. The card further includes an unlocking member having an unlocking portion of a round-coin shape. A shank portion of the unlocking member is pivotably connected to the card body to allow the unlocking member to be moved between a first position and a second position. When the unlocking member is in the first position, the unlocking portion is folded into the card body; and when the unlocking member is in the second position, the unlocking portion sticks out of the card body and is adapted to be inserted into a slot of a trolley lock to release the trolley lock.

### BACKGROUND OF THE INVENTION

1. Field of the Invention

The present invention relates to a card for a trolley lock and, more particularly, to a card with an unlocking member, wherein the unlocking member is capable of releasing the trolley lock and can be conveniently folded in and unfolded out from the card.

2. Description of the Related Art

Hypermarkets usually provide trolleys at the entrance thereof to allow customers to carry their purchases therein. And in order to conveniently manage the shopping trolleys, a lock is conventionally disposed on a handle of each shopping trolley. A lock hole is provided in a front end of the lock, and a chain with a lock plate is disposed on a rear end of the lock. The lock plate of a shopping trolley can be inserted into the lock hole of another shopping trolley, allowing the two shopping trolleys to be joined together with the chain. Furthermore, a slot is disposed in the rear end of the lock to allow insertion of a coin. When the customer inserts a coin into the slot, the lock plate can be released. On the other hand, when the customer inserts the lock plate of another trolley into the lock hole of the shopping trolley, the coin can be pushed out of the trolley lock. However, since most wallets are not designed to store coins, it is common that the customers do not have coins with them when they go shopping in a hypermarket. Therefore, the customers have to go to information desk for money exchange, causing inconvenience thereof.

There has been card for storing coins disclosed by prior arts; however, the process of retrieving the coin from the card and/or storing the coin into the card is not convenient, and the coin inside of the card falls out easily.

### BRIEF SUMMARY OF THE INVENTION

Thus, an objective of the present invention is to provide a card for a trolley lock which includes an unlocking member capable of releasing the trolley lock. The unlocking member is pivotably connected to the card and can be conveniently folded into and unfolded out from the card.

To achieve this and other objectives, a card for a trolley lock of the present invention includes a card body and an unlocking member. The card body includes front and rear ends and a recess extending from the front end toward the rear end of the card body. The recess includes a first section adjacent to the front end of the card body. The card body further includes at least one first joining portion located in the first section of the recess. The unlocking member includes a shank portion and an unlocking portion extending outwards from an end of the shank portion and being of a coin shape. The shank portion includes at least one second joining portion which is pivotably engaged to the first joining portion of the card body so that the unlocking member is rotatable relative to the card body and moveable between a first position and a second position. When the unlocking member is in the first position, the unlocking portion is folded in the recess of the card body, and when the unlocking member is in the second position, the unlocking portion is unfolded out from the card body and adapted to be inserted into a slot of a trolley lock.

In a preferred form, the card body further includes an upper surface, and the recess extends from the front end of the upper surface toward but spaced from the rear end of the upper surface of the card body. The card body further includes two spaced sides, and the recess is disposed between the two sides of the card body. A notch is formed in the first section of the recess and extends from an outer end of the first section to the front end of the card body. The notch has a width defined by two notch walls. The card body includes two opposed first joining portions each being a pivot protruding from one of the notch walls. The unlocking member includes two second joining portions each being a slot provided in one of two lateral sides of the shank portion and pivotably engaged with one of the two pivots.

Preferably, the card body further includes at least one first positioning portion provided in the second section of the recess. The unlocking member further includes at least one second positioning portion disposed in one of two lateral side of the unlocking portion and engaged with the first positioning portion of the card body when the unlocking member is in the first position.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is an exploded view of a card for a trolley lock in accordance with a first embodiment of the present invention.

FIG. 2 shows a perspective view of the card of FIG. 1.

FIG. 3 shows a cross-sectional view of the card of FIG. 2 according to section line 3-3 of FIG. 2.

FIG. 4 shows a cross-sectional view of the card of FIG. 2 according to section line 4-4 of FIG. 2.

FIG. 5 is a perspective view similar to FIG. 2, wherein an unlocking member of the card is unfolded outwards.

FIG. 6 shows a perspective view of the card of the present invention and a trolley lock.

FIG. 7 is an exploded view of a card for a trolley lock in accordance with a second embodiment of the present invention.

FIG. 8 shows a perspective view of the card of FIG. 7 and an enlarged view of a circled portion of the card of FIG. 8.

FIG. 9 is a perspective view similar to FIG. 8, wherein an unlocking member of the card is unfolded outwards.

### DETAILED DESCRIPTION OF THE INVENTION

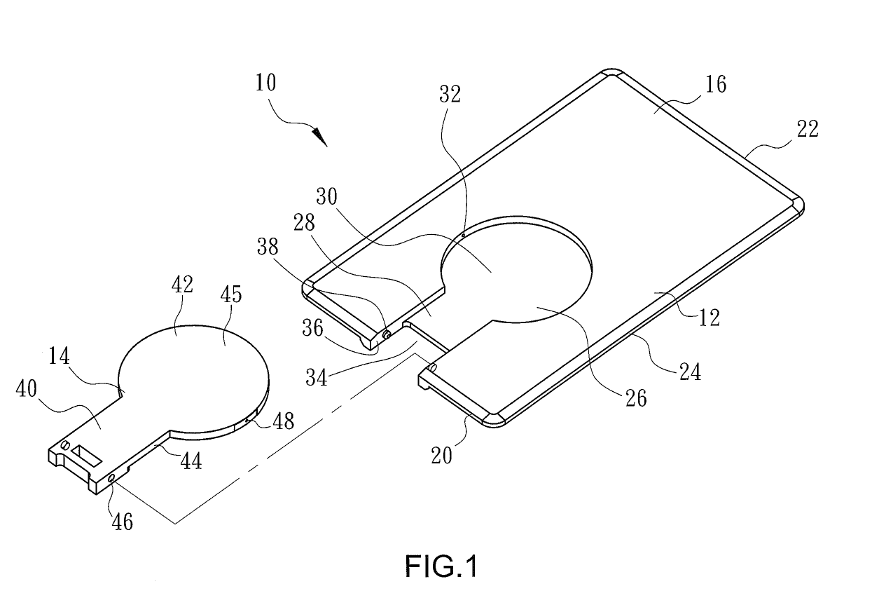

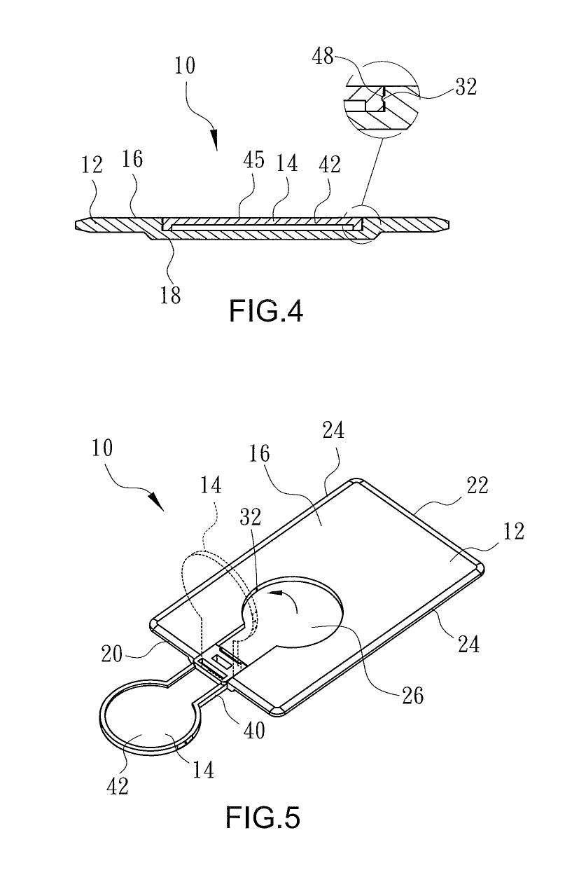

A card for a trolley lock according to a first embodiment of the present invention is shown in FIGS. 1 through 6 of the drawings and generally designated 10. Card 10 includes a card body 12 and an unlocking member 14. The card body 12 is of the size similar to general credit cards, telephone cards, and membership cards and can be stored in a wallet for a user to carry around easily. Card body 12 includes upper and lower surfaces 16 and 18 opposed in a thickness direction. Card body 12 further includes front and rear ends 20 and 22 spaced in a length direction perpendicular to the thickness direction and two sides 24 spaced in a width direction perpendicular to the thickness and length directions. The upper surface 16 and/or lower surface 18 of card body 12 can be printed of information such as an advertisement, a pattern, a catalog, and daily supplies.

The card body 12 further includes a recess 26. In this embodiment, recess 26 is provided between two sides 24 of upper surface 16 of card body 12 and extends from the front end 20 of the card body 12 toward but spaced from the rear end 22 of the card body 12. The recess 26 includes a first section 28 adjacent to the front end 20 and a second section 30 having a round-coin shape. The card body 12 further includes at least one first positioning portion 32. According to the preferred form shown, the card body 12 includes two opposed, first positioning portions 32, and each first positioning portion 32 is a protrusion spot and disposed on a surrounding of the second section 30 of the recess 26. However, it can be appreciated that each first positioning portion 32 can also be disposed inside the second section 30 of the recess 26 or on a surrounding of the first section 28. Further, a notch 34 is formed in the recess 26 and extends from an outer end of the first section 28 to the front end 20 of the card body 12. A width of the notch 34 in the width direction is defined by two opposed notch walls 36. The card body 12 further includes at least one first joining portion 38. In the preferred embodiment, the card body 12 includes two opposed, first joining portions 38, and each first joining portion 38 is a pivot protruding from one of the notch walls 36 in the width direction.

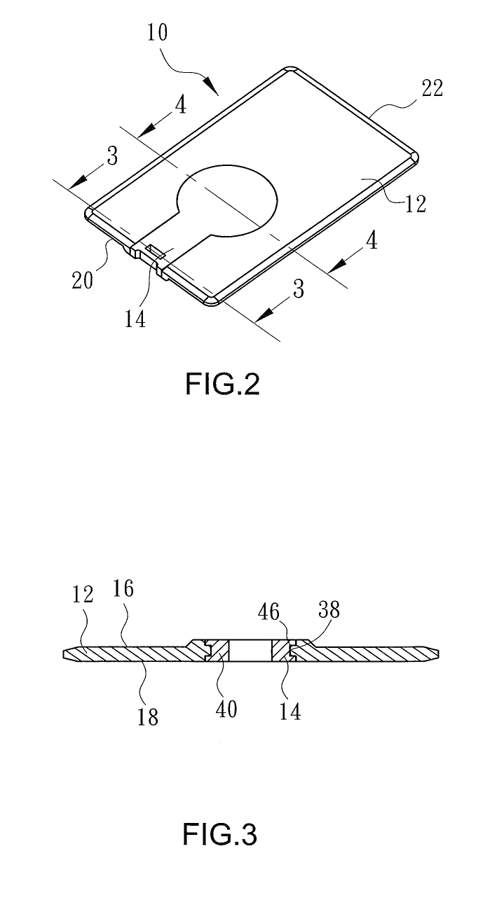

The unlocking member 14 includes a shank portion 40 and an unlocking portion 42 spaced from the shank portion 40 in the length direction. The unlocking member 14 further includes two lateral sides 44 spaced in the width direction. In the preferred embodiment, the unlocking member 14 has approximately the same shape as the recess 26 of the card body 12 to allow the unlocking member 14 to fit with and received in the recess 26. Specifically, the shank portion 40 of the unlocking member 14 has a shape corresponding to the first section 28 of the recess 26, and the unlocking portion 42 of the unlocking member 14 has a shape corresponding to the coin shape of the second section 30 of the recess 26. The thickness of the unlocking member 14 is approximately the same as the depth of the recess 26, thereby allowing a top surface 45 of the unlocking member 14 to flush with the upper surface 16 of the card body 12 when the unlocking member 14 is received in the recess 26. The unlocking member 14 further includes two second joining portions 46 to pivotably join with the two first joining portions 38 of the card body 12, thereby allowing the unlocking member 14 to be moved relative to the card body 12 between a first position and a second position. In the embodiment, the second joining portions 46 are slots disposed in two lateral sides 44 of the shank portion 40 respectively. However, it can be appreciated that the two second joining portions 46 can be pivots and the two first joining portions 38 can be slots. When the unlocking member 14 is in the first position, the unlocking portion 42 is folded inside the recess 26 of the card body 12 (see FIG. 2). In this case, pressing an outer end of the shank portion 40 of the unlocking member 14 to allow the unlocking member 14 to be rotated about a pivot axis defined by the first joining portions 38, and thereby moving the unlocking portion 42 to the second position that protrudes out of the card body 12 (see FIG. 5). The unlocking member 14 further includes two second positioning portions 48. Further, when the unlocking member 14 is in the first position, the second positioning portions 48 are engaged with the first positioning portions 32 to fix the unlocking member 14 in the first position. In the embodiment, each second positioning portion 48 is a cavity disposed in one of the two lateral sides 44 of the unlocking portion 42. However, it can be appreciated that the second positioning portions 48 can be protrusion spots and the first positioning portions 32 can be cavities.

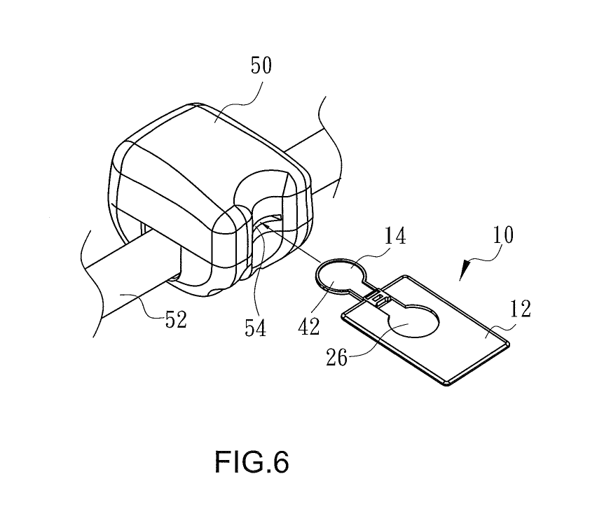

The card 10 can be stored inside the wallet or designed as a key ring for the users to carry around easily. When in use, rotate the unlocking member 14 to the second position to unfold it so that the unlocking portion 42 protrudes from the card body 12 (see FIG. 6). The unlocking portion 42 is then capable of being inserted into a slot 54 of a trolley lock 50 on a trolley handle 52 to release the trolley lock 50. And after use, lift the unlocking portion 42 upwards relative to the card body 12 to move the unlocking member 14 to the first position, thereby allowing the unlocking member 14 to be received inside the recess 26 of the card body 12.

In practice, after inserting the unlocking portion 42 into the slot 54, the card body 12 can be rotated relative to the unlocking portion 42 to an appropriate angle, and therefore the information printed thereon can be shown to the customers, providing a good advertising effect. Or, the card body 12 can be printed of or stuck on a daily supplies list, thereby helping the user to purchase products he or she needs. Besides, the card 10 according to the preferred teachings of the present invention can be used as a free gift.

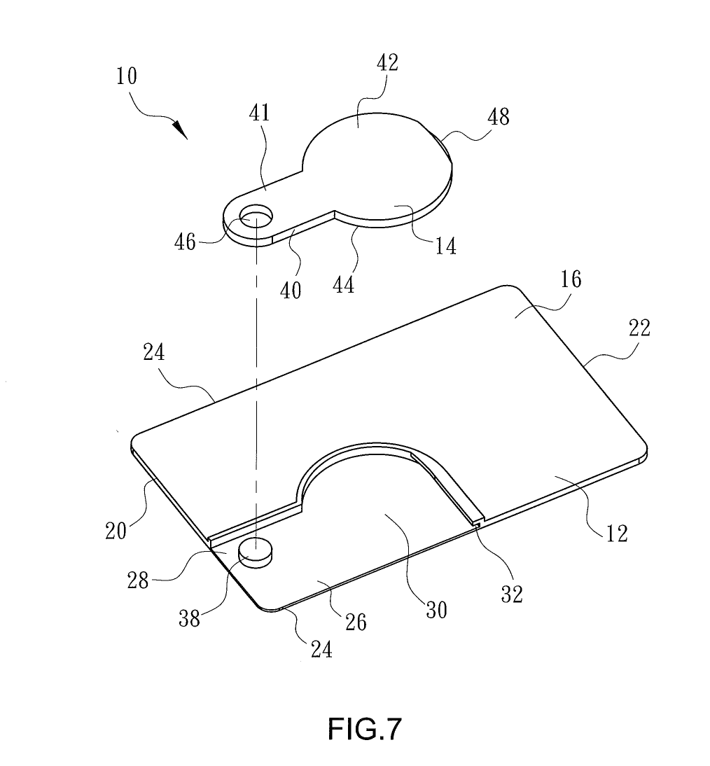

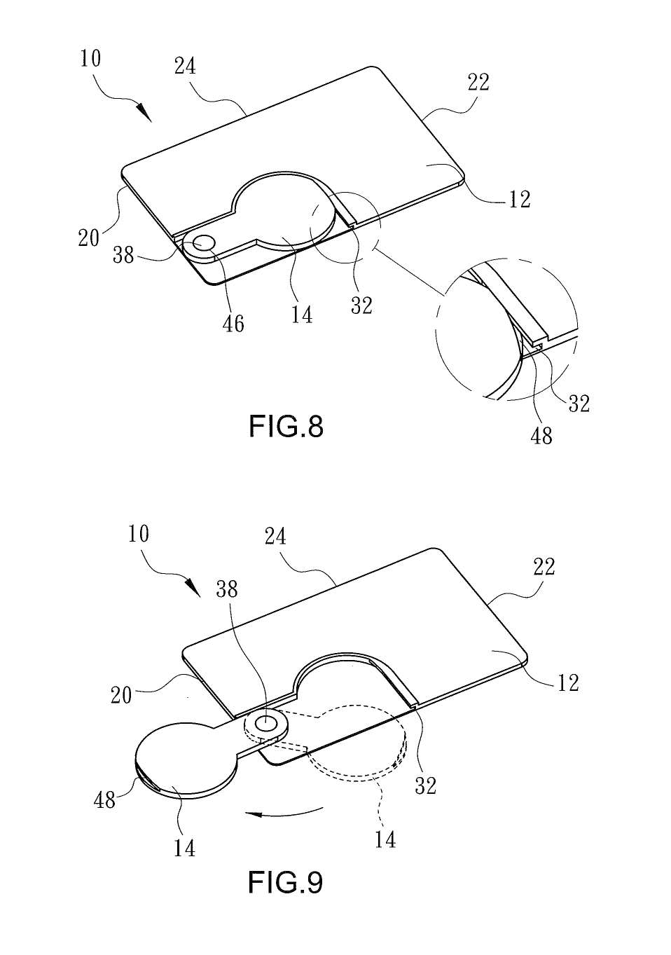

FIGS. 7 through 9 illustrate a card 10 according to a second embodiment of the present invention. According to this second embodiment, the recess 26 of the card 10 extends from front end 20 of one of the two sides 24 of the upper surface 16 of the card body 12 toward but spaced from the rear end 22 thereof. The recess 26 is not limited to be disposed in the upper surface 16 of the card body 12; the recess 26 can also be disposed in the lower surface 18 of the card body 12 or between the upper and lower surfaces 16 and 18. In this embodiment, the card body 12 includes only a first positioning portion 32 and a first joining portion 38, wherein the first positioning portion 32 is a groove disposed in a rear end of the second section 30 of the recess 26, and the first joining portion 38 is a pivot protruding from first section 28 of the recess 26 in the thickness direction. The unlocking member 14 includes only a second joining portion 46 and a second positioning portion 48, wherein the second joining portion 46 is a through-hole disposed in shank portion 40 and pivotably receiving pivot 38, thereby allowing the unlocking member 14 to be rotated between the first and second positions about a pivot axis defined by the pivot 38. The second positioning portion 48 is a thinned portion disposed at a rear end of unlocking portion 42 and engaged with first positioning portion 32 of card body 12 when the unlocking member 14 is in the first position.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A card for a trolley lock comprising:
a card body including front and rear ends and a recess extending from the front end toward the rear end of the card body, with the recess including a first section adjacent to the front end of the card body, with the card body further including at least one first joining portion located in the first section of the recess; and
an unlocking member including a shank portion and an unlocking portion extending outwards from an end of the shank portion and being of a coin shape, with the shank portion including at least one second joining portion, with the second joining portion being pivotably engaged to the first joining portion of the card body so that the unlocking member is rotatable relative to the card body and moveable between a first position and a second position;
wherein when the unlocking member is in the first position, the unlocking portion is folded in the recess of the card body; and
wherein when the unlocking member is in the second position, the unlocking portion is unfolded out from the card body and adapted to be inserted into a slot of a trolley lock.

2. The card for a trolley lock according to in claim 1, with the card body further including an upper surface, and with the recess extending from the front end of the upper surface toward but spaced from the rear end of the upper surface of the card body.

3. The card for a trolley lock according to claim 2, with the card body further including two spaced sides, with the recess disposed between the two sides of the card body, with a notch formed in the recess and extending from an outer end of the first section of the recess to the front end of the card body, with the notch having a width defined by two notch walls, with the card body including two opposed first joining portions, with each of the two first joining portions being a pivot protruding from one of the notch walls, with the unlocking member including two second joining portions, and with each of the two second joining portions being a slot provided in one of two lateral sides of the shank portion and pivotably engaged with one of the two pivots.

4. The card for a trolley lock according to claim 3, with the card body further including at least one first positioning portion, with the first positioning portion being a protrusion spot provided in the second section of the recess, with the unlocking member further including at least one second positioning portion, with the second positioning portion being a cavity disposed in one of two lateral sides of the unlocking portion, and with the cavity of the unlocking member engaged with the protrusion spot of the card body when the unlocking member is in the first position.

5. The card for a trolley lock according to claim 3, with the second section of the recess having a coin shape.

6. The card for a trolley lock according to claim 2, with the card body further including two spaced sides, with the recess extending from the front end of one of the two sides of the upper surface of the card body toward but spaced from the rear end of the card body, with the first joining portions of the card body being a pivot protruding from the first section of the recess, and with the second joining portion being a through-hole disposed in the shank portion and pivotably engaged with the pivot.

7. The card for a trolley lock according to claim 6, with the card body further including at least one first positioning portion, with the first positioning portion being a groove provided in a rear end of the second section of the recess, with the unlocking member further includes at least one second positioning portion, with the second positioning portion being a thinned portion disposed at a rear end of the unlocking portion, and with the thinned portion of the unlocking member engaged with the groove of the card body when the unlocking member is in the first position.
